(19) United States
(12) Patent Application Publication
(10) Pub. No.: US 2008/0015980 A1
(43) Pub. Date: Jan. 17, 2008

(54) SYSTEM AND METHOD FOR MANAGING TARGETED DONATIONS AND GIVING

(76) Inventors: W. Cord Pereira, Boise, ID (US); Robert (Bob) Sesek, Boise, ID (US); William L. Pereira, Reno, NV (US)

Correspondence Address: Zarian Midgley & Johnson PLLC, P.O. BOX 170440, BOISE, ID, 83716, US

(21) Appl. No.: 11/465,400

(22) Filed: Aug. 17, 2006

Related U.S. Application Data
(60) Provisional application No. 60/807,029, filed on Jul. 11, 2006.

(51) Int. Cl. G06Q 40/00

(52) U.S. Cl. 705/39

(57) ABSTRACT

A system and method provides organizations and donors with the ability to transact targeted donations and gifts, which may include property, services and anything of value that can be sold, preferably in an online marketplace. When the item is sold, cash proceeds can flow to the beneficiary organization through an agent of the donor. The system allows for the donor to find and select a target beneficiary for funds generated by the sale of property, which may include the organization, campaigns, sub-campaigns and individual member accounts. The system allows beneficiary organizations to authorize, create and manage their own target beneficiary accounts for the organization, campaigns, sub-campaigns and individual member accounts.

### RELATED APPLICATION

This application claims priority under 35 U.S.C. 119(e) to U.S. Provisional Patent Application Ser. No. 60/807,029 filed Jul. 11, 2006 and entitled SYSTEM AND METHOD FOR MANAGING TARGETED DONATIONS AND GIVING, the disclosure of which is incorporated herein in its entirety.

### BACKGROUND

Non-profit organizations often setup endowments and campaigns for specific initiatives such as capital campaigns, scholarships and annual funds. Donors can elect to give specifically to these programs. With current online giving programs however, charity organizations are limited to registering themselves as a single entity, and therefore the donor proceeds from sales are going to the charity on a donor-perceived unrestricted basis, meaning that the charity can use the funds in any manner they choose. This limitation significantly impacts the charity organization's ability to fully appeal to the instinctive preferences of donors which have proven to be successful in the offline world.

Moreover, many non-profit organizations not only have specific programs and campaigns for which they need to raise funds, but many also have a constituent membership who participate in the organization where they are required to pay participation fees to the organization. Nonprofit organizations do not have a practical solution to implement membership level fundraising programs.

Current online fundraising systems do not allow donors to select from a database of a charity organization's programs, campaigns, sub-campaigns and individual members. Moreover, these current systems do not allow donors in a single transaction to target proceeds across multiple organizational campaigns and members, (whether non-profit or for-profit or as an individual).

Large institutional fundraising organizations, such as hospitals and universities, structure their fundraising campaigns towards high net worth individuals and foundation sources where the expected result is large cash or in-kind donations. This structure is best suited for limited size development staffs. As a result, large potential sources for donations, such as a college alumni body in the case of a University, are neglected. These sources, while small individually, collectively represent a large, untapped opportunity for fundraising organizations.

Many organizations, such as private high schools, utilize silent auctions as a significant fundraising method, usually in conjunction with a weekend special event. Auction items are usually displayed in an exhibit format for a limited time to a narrow audience. The buyers of these items are typically the event attendees, but a larger potential buyer pool, accessible through online selling markets, is not reached. Buyers' purchases are not targeted to benefit specific programs, campaigns, sub-campaigns and individual members.

### SUMMARY

Using the Internet with online sales markets, the technological potential exists for non-profit organizations to go well-beyond even targeted fundraising for specific campaigns; they can potentially setup structured fundraising campaigns that specifically benefit individual members of an organization. This will act as a catalyst for increased fundraising because donors can now support individuals from an entirely new source, the sale of property allowing organizations to customize their giving targets, which includes individual members of their organizations. By doing so, charitable contributions through the sale of property will increase substantially.

In one embodiment, a method for managing donations comprises establishing a primary beneficiary account for each of a plurality of beneficiary organizations, and presenting the beneficiary organizations with an interface that enables the beneficiary organizations to create a plurality of beneficiary sub-accounts within their corresponding primary beneficiary account. The method further comprises listing donated property as being for sale on behalf of a donor without accepting title to the donated property, and depositing at least some of the proceeds from the sale of the donated property into one or more beneficiary sub-accounts designated by the donor.

In another embodiment, a method for distributing the proceeds from the sale of donated property comprises establishing one or more beneficiary accounts for each of a plurality of beneficiaries. At least one beneficiary account comprises a target amount. The method further comprises receiving the proceeds from the sale of property sold by a donor, and donating the proceeds from the sale of the property to a plurality of beneficiary accounts based on one or more customized rules created by the donor for distribution of the proceeds. At least one of the customized rules defines a sequence for distributing proceeds to the beneficiary accounts based on their associated target amounts.

In another embodiment, a method for reporting donation transactions, comprises receiving donated property from a donor and providing a first receipt to the donor at the time the donated property is received. The first receipt indicates the estimated fair market value of the donated property. The method further comprises selling the donated property in an online marketplace, and determining whether the selling price of the donated property differs from the estimated fair market value by more than a selected threshold amount. If so, the donor is provided with a second receipt indicating the selling price of the donated property.

In another embodiment, a method for managing donations comprises receiving a cash donation from a donor, as well as donated property to be sold in an online marketplace, and transferring at least a portion of the cash donation to a designated beneficiary. The method further comprises selling the donated property in the online marketplace, and refunding to the donor at least a portion of the proceeds from the sale of the donated property.

In another embodiment, a method for promoting donation activity comprises making donated property available for sale, and notifying potential purchasers of the donated property that the proceeds from the sale of the donated property will benefit one or more designated beneficiaries. The method further comprises enabling the potential purchasers to make a donation targeted to the one or more designated beneficiaries or to other beneficiaries.

In another embodiment, a method for targeting donations to specific beneficiaries comprises establishing an account for one or more beneficiary organization members, and presenting a donor with an interface that enables the donor to target the proceeds from the sale of donated property to a selected account associated with a specific beneficiary organization member. The method further comprises receiving the proceeds from the sale of the donated property sold in an online marketplace, and depositing at least some of the proceeds from the sale of the donated property into the account selected by the donor.

These and other embodiments of the present application will be discussed more fully in the detailed description. The features, functions, and advantages can be achieved independently in various embodiments of the present invention, or may be combined in yet other embodiments.

### BRIEF DESCRIPTION OF THE DRAWINGS

FIG. 1 is a block diagram showing the overall environment in which a Donation System operates.

FIG. 2 is a block diagram showing the Donation System in more detail.

FIG. 3 is a block diagram showing more detail of a typical beneficiary organization.

FIG. 4 is a flowchart showing an exemplary donor-seller use of the Donation System.

FIG. 5 is a flowchart showing an exemplary use of the Donation System from the perspective of a beneficiary.

FIG. 6 is a flowchart showing an exemplary use of the Donation System from the perspective of a buyer.

FIG. 7 is a flowchart showing an exemplary campaign management flow.

FIG. 8 is a block diagram depicting a generic hierarchical targeting schema.

FIG. 9 is a block diagram showing an example of a hierarchical targeting schema.

### DETAILED DESCRIPTION

In the following detailed description, reference is made to the accompanying drawings that form a part hereof, and in which is shown by way of illustration specific illustrative embodiments in which the invention may be practiced. These embodiments are described in sufficient detail to enable those skilled in the art to practice the invention, and it is to be understood that other embodiments may be utilized and that various changes may be made without departing from the spirit and scope of the present invention. The following detailed description is, therefore, not to be taken in a limiting sense.

The following terms will be used throughout the detailed description. “Beneficiary Organization” or “Beneficiary” is defined as any legal non-profit organization, for-profit organization, government agency or enterprise, or an individual who will receive net proceeds as the result of one or more donations or gifts. “Donor” is defined as any individual, non-profit organization, for-profit organization, government agency or enterprise that is donating or gifting goods, services or cash to one or more Beneficiary Organizations. “Property” or “Donated Property” is defined as any item with commercial value including, but not limited to, personal property, real estate, trade services, consumer services, professional services, store credits and cash. “Member” or “Beneficiary Organization Member” is defined as the lowest level of recipient for donations (in many cases, an individual person), that is targeted for the receipt of specific donations. “Donation” or “Donate” is defined as the act of a Donor gifting property to benefit one or more Beneficiary Organizations and/or their Members.

“Donation System” or “System” is used to designate the disclosed system for managing donations, as described in more detail below. This Donation System can exist in a variety of business models including, but not limited to: 1) a web application service offered directly to Beneficiary Organizations and prospective Donors; 2) a web service extension supporting third party commerce and auction management system platforms; and/or 3) an added value consumer service offered by traditional retailers to their patrons.

“Third Party Services” are defined as services with which the Donation System integrates in order to implement business models including, but not limited to: 1) commerce and auction management systems; 2) merchant services; 3) shipping services; 4) research databases; 5) Beneficiary Organization websites and databases; 6) communication services and 7) syndication and marketing services.

A “Hierarchical Tree” is defined as a hierarchical mapping of a Beneficiary Organization showing the organizational structure of the Beneficiary Organization, detailing programs and recipients eligible for donations. This “Tree” may have an arbitrary number of “Branches” at each level within the tree.

“Hierarchical Tree Template” is defined as a template used by Beneficiary Organizations to facilitate easier mapping of campaigns, sub-campaigns and members into a donation database.

“Campaign” or “Account” is defined as a specific program, activity, project, need, or any grouping of these that a Beneficiary Organization creates to be eligible for targeted fundraising. A Campaign may be temporary, periodic (e.g., annual), or ongoing. “Sub-Campaign” or “Sub-Account” or “Program” is defined is a specific subset of a Campaign or a broader Sub-campaign with a narrower or more specific focus. “Drill-down” is defined as the act of moving deeper and more specifically through sub-campaigns and members within a “Hierarchical Tree” or actual Beneficiary Organization hierarchical tree. “Beneficiary ID” or “Beneficiary Code” is defined as the unique identifier associated with individual “Campaigns”, “Sub-campaigns”, and “Members” within a Beneficiary Organization in the Donation System. The Beneficiary ID may be created by any number of methods including, but not limited to, assigning unique numerical and/or character codes to campaigns, sub-campaigns and members.

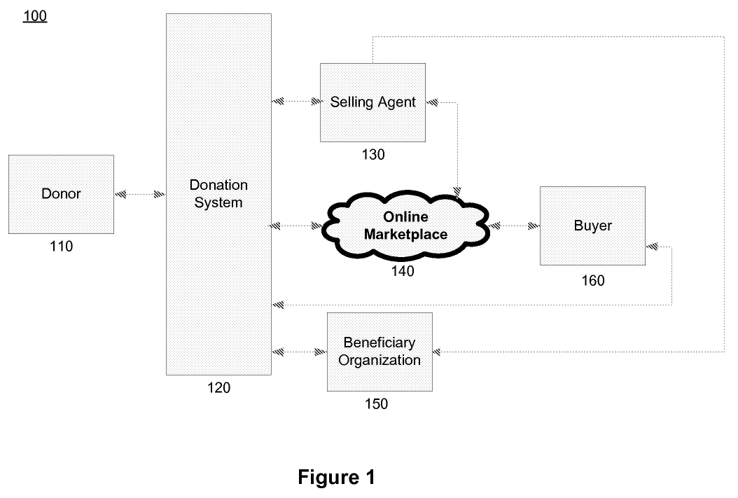

FIG. 1 shows a simplified block diagram of Environment 100, which includes the donation management method of targeting donations and giving. Environment 100 includes: the Donor 110, the Donation Management System 120, an optional Third Party Selling Agent 130, a Marketplace 140 (although Marketplace 140 is shown as an online marketplace, Marketplace 140 may be an online market, a traditional marketplace or any combination of these), a Beneficiary Organization 150 and a Buyer 160.

The Donor 110 interacts directly with the Donation System 120. In some embodiments, it may appear to the Donor 110 that the Donor 110 is dealing directly with either the Selling Agent 130 or the Beneficiary Organization 150. The Donation Management System 120 interacts with the Selling Agent 130, the Marketplace 140, and the Beneficiary Organization 150. The Donation Management System 120 in some embodiments may also interact directly with the Buyer 160. The Selling Agent 130 interacts with the Donation Management System 120 and the Marketplace 140. In some embodiments, the Selling Agent 130 may also interact with the Beneficiary Organization 150.

The Marketplace 140 is where the donated property changes hands and may represent any combination of selling environments. In some embodiments, Marketplace 140 is an online marketplace, such as eBay™, Ubid™ and the like. It is understood that Marketplace 140 includes not only the auction platform (e.g. eBay™, Ubid™, etc.), but also includes any other marketplace management layers that may be utilized by sellers within the Marketplace 140, such as Infopia™ and Marketworks™. These marketplace management layers are utilized by many “power-sellers” within the online marketplace and are well known to those skilled in the art.

The Beneficiary Organization 150 primarily interfaces with the Donation Management System 120, but may also interact directly with the Selling Agent 130 in some embodiments. The Buyer 160 interacts with the Marketplace 140 when buying donated property. The Buyer 160 may also interact with the Donation Management System 120 in some more sophisticated embodiments, as will be discussed further. Interfaces between major components are shown in the diagrams as single interfaces for simplicity. In actual practice, there may be multiple interfaces between these components. For example, Beneficiary Interface 250 used to transfer funds from the Donation Management System 120 to the Beneficiary Organization's Merchant Account 380 and used for the Beneficiary Organization 150 to manage the Beneficiary Data Base 255, could in practice be different interfaces.

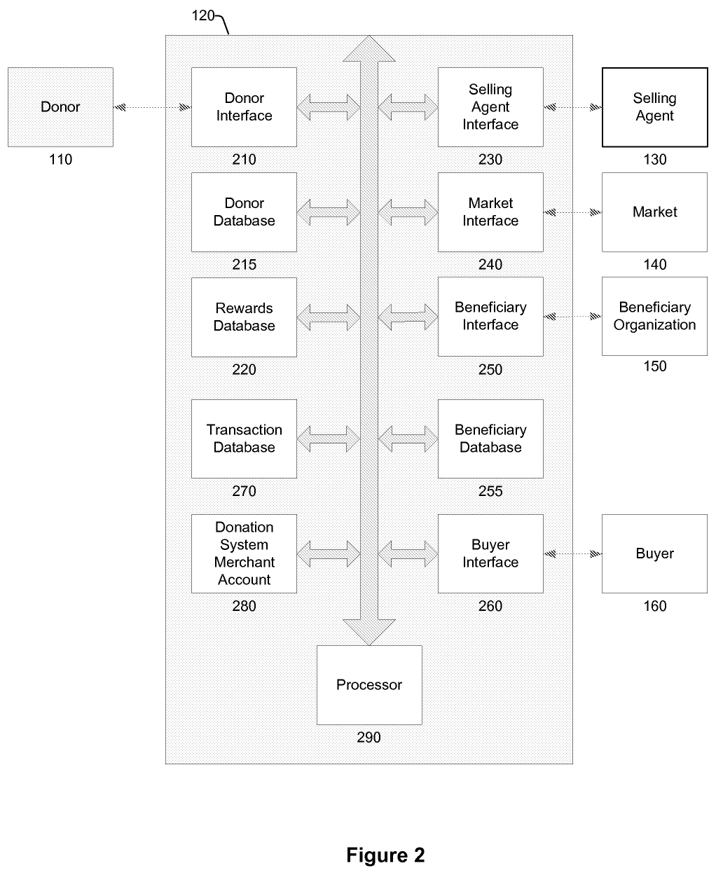

FIG. 2 is a block diagram showing more detail of the Donation Management System 120 from FIG. 1. System 120 is representative of one exemplary embodiment. The Donation Management System 120 may comprise a single web-server and associated linked databases or any combination of multiple web-servers and other associated databases. In one embodiment, the Donation Management System 120 is a scalable system that includes one or more web-servers and redundant data backup, such as RAID 5 servers or the like. The various databases and interfaces are shown in FIG. 2 as being contained within the web-server; this is only one of many possible embodiments. In some embodiments, all databases are secure and redundant, but more streamlined implementations may not include these aspects.

In the embodiment shown in FIG. 2, System 120 comprises a Processor 290 coupled to a plurality of interfaces (e.g., Donor Interface 210, Selling Agent Interface 230, Market Interface 240, Beneficiary Interface 250, and Buyer Interface 260), a plurality of databases (e.g., a Donor Database 215, a Rewards Database 220, a Beneficiary Database 255, and a Transaction Database 270), and a Donation System Merchant Account 280 via a bus depicted as arrows. Processor 290 represents one or more processors, which can be used to run the Donation Management System 120. In some embodiments, Processor 290 implements any logic and/or programming associated with the System 120 and its internal and external communications.

In operation, the Donor Interface 210 allows the Donor 110 to select one or more Beneficiaries from the Beneficiary Database 255. In some embodiments, the Donor Interface 210 is browser-based. The Donor Database 215 tracks the Donors 110 and associated donor information, allowing receipts and other information, such as thank you notes, to be provided to the Donors 110.

In the illustrated embodiment, System 120 includes an optional Rewards Database 220. The Rewards Database 215 keeps track of any rewards that may be offered to Donors 110. These rewards may be offered by the Beneficiary Organization 150 or by a Selling Agent 130 or by the Donation Management System 120 itself as a way to provide Donors 110 with incentive to give more. Examples of rewards include a coffee mug from the Beneficiary Organization 150 for any Donor 110 donating more than $100 worth of property and a tote bag for donations of property exceeding $1,000.

Donation System 120 of FIG. 2 shows a Selling Agent Interface 230. This Selling Agent Interface 230 allows Selling Agents 130 to assist Donors 110 in the sale of donated property. In some embodiments, the Selling Agent Interface 230 may allow the Selling Agent 130 to modify the Donor Interface 210 to allow for a “Branded look and feel” to the Donor 110. For example, a Selling Agent 130 such as i-Soldit™ could provide a browser-based interface indicating to Donors 110 that their donation is an “i-Soldit™ for Charity” transaction. This branded interface would still access the Beneficiary Database 255 within System 120, allowing the Donor 110 to target specific Beneficiary Organizations 150 for their donation.

The Selling Agent 130 represented in this simplified diagram may actually represent more than a single entity. For example, there may be a Selling Agent 130 that actually lists and sells the donated property, such as iSoldit™, and one or more additional Selling Agents 130 that provide a value-added service to enhance the value of the donated property. For example, a bike shop may provide safety and certification inspections for donated bicycles, or a guitar retailer may provide a Luthier certification for a donated guitar. By providing these added-value donation services to their customers, retailers, such as bike shops and music stores, will indirectly increase sales as a result of goodwill and loyalty.

The System 120 shown in FIG. 2 includes a Market Interface 240, which allows for information about the Beneficiary Organization 150 and in some cases about the Donor 110 to be shared through the Marketplace 140 to the Buyers 160. For example, information and/or links to information about the Beneficiary Organization 150 could be provided to the Marketplace 140. This information could include general organization information, specific member information, such as a picture of the direct beneficiary, or information about other property that is for sale to benefit that specific Beneficiary Organization 150, to name a few. Transaction information is also transferred via the Market Interface 240 to the Transaction Database 270.

The System 120 of FIG. 2 includes a Beneficiary Interface 250, which allows the Beneficiary Organization 150 to access, populate and modify the Beneficiary Database 255. The Beneficiary Interface 250 also allows the Beneficiary Organization 150 to access the Donor Database 215 and to receive funds transferred from the Donation System Merchant Account 280. In some embodiments, the Beneficiary Organization 150 may be allowed to modify the Donor Interface 210 to achieve a “Beneficiary Branded look and feel” for their specific organization. For example, the City of Boise as a Beneficiary Organization 150 may mandate that any auctions listed within their website maintain the look and feel of the rest of their site web pages, and all non-city branding and logos be removed.

The System 120 of FIG. 2 includes an optional Buyer Interface 260, which allows the purchaser of the donated property, Buyer 160, to be presented with information regarding the beneficiary of the property sale, as well as other potential beneficiaries and to make a donation to one or more of these beneficiaries. In the event that one or more of these beneficiaries is a charitable organization, the Donation Management System 120 would allow the Buyer 160 to make the donation and would provide tax receipts to the Buyer 160. This enhancement to the system allows Beneficiary Organizations 150 to extend their reach to more potential donors, that is, the buyers of the donated property. These buyers were simply buying used merchandise in the marketplace, but now may become donors themselves.

FIG. 2 shows a Transaction Database 270, which contains transaction information for all donated property from Donors 110 and all purchases and donations from Buyers 160, as well as information about any fees/costs from Selling Agents 130. It is understood that the data stored in Databases 215, 220, 255 and 270 may be stored in other database configurations that might have a single database or more databases than shown in this example.

The System 120 of FIG. 2 includes a Donation System Merchant Account 280, which represents one or more accounts into which funds can be transferred. Examples would include checking accounts, credit card accounts, and PayPal™ accounts. These accounts are used to receive and distribute funds received as donations and/or as the result of the sale of donated property in Marketplace 140.

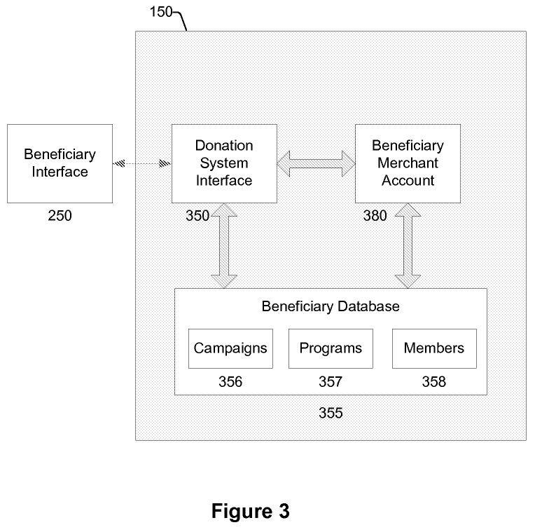

FIG. 3 shows a block diagram of Beneficiary Organization 150. The Beneficiary Organization 150 interacts with the Beneficiary Interface 250 of Donation Management System 120 through its Donation System Interface 350. In some embodiments, this Donation System Interface 350 is browser based. The Beneficiary Organization 150 may have one or more Beneficiary Merchant Accounts 380 used to accept donated funds and to distribute funds internally. The Beneficiary Organization 150 may have separate accounts for each Beneficiary Organization Member 358 or use other methods to track and account for targeted donation usage at various levels within the organization.

The Beneficiary Organization 150 has a Beneficiary Organization Database 355, which contains data about Beneficiary Organization's Campaigns 356, Programs 357, and Members 358. This database 355 will normally be a superset of the Beneficiary Database 255 in the Donation Management System 120 with respect to the particular Beneficiary Organization 150. The Beneficiary Organization Database 355 may have entries for Campaigns 356, Programs 357 and individual Members 358.

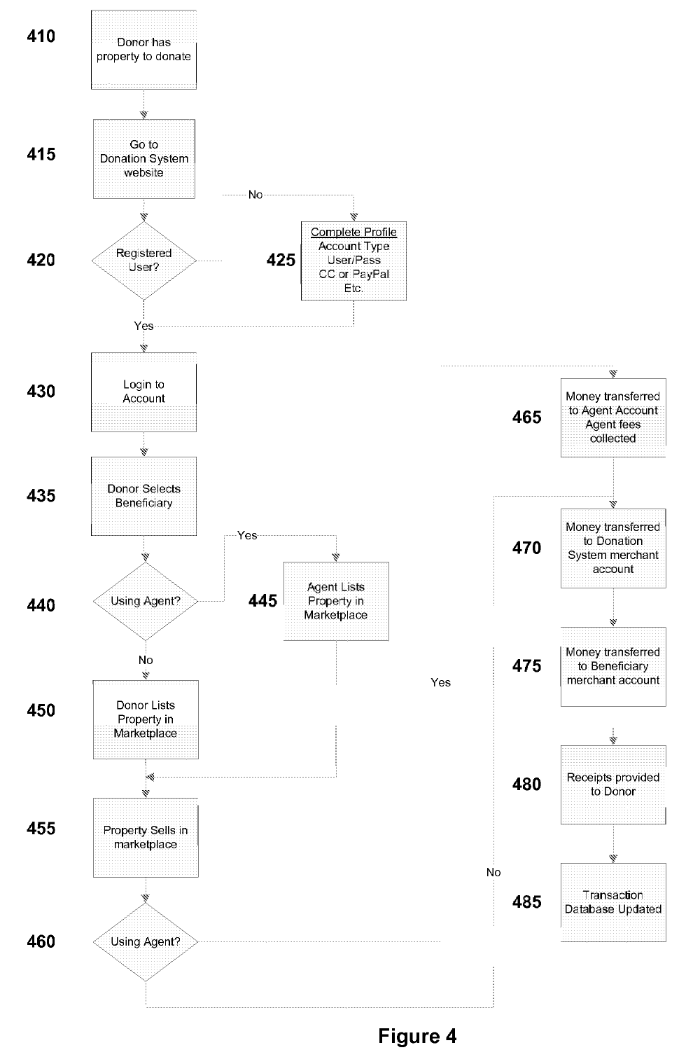

FIG. 4 is a simplified flow chart showing an exemplary use of the System 120 from the perspective of a Donor 110. The flow chart begins at Block 410 where the Donor 110 has property that they wish to donate to a specific Beneficiary 150. This property may be new or used goods or services. In some embodiments, the Donor 110 can simultaneously donate property to be sold and also advance cash to the selected Beneficiary 150. Once the donated property is sold, the Donor 110 can then receive a refund of the some or all of the advanced cash from the Beneficiary 150, a Selling Agent 130, or a system administrator.

At Block 415, the Donor 110 interacts with the Donation Management System 120 through the Donor Interface 210. In this example, the interface 210 comprises a browser based interface that is connected to the Donation Management System 120 via the Internet.

At Block 420, the Donor 110 is queried about being a registered user of the Donation Management System 120. If they are not, they are presented with a new user account login at Block 425. Part of this login process involves determining the account type for the user. In this example, the account type is for a Donor/Seller. Other account types may include Beneficiary Organization, Beneficiary Member, Agent/Power Seller, and Administrative account; other account types not listed could also be implemented. At Block 430 the Donor 110 logs onto their account. The user may update, edit or delete the information in their donor account.

At Block 435, the Donor 110 selects one or more beneficiaries from the Beneficiary Database 255 within the Donation Management System 120. In some embodiments, the Donor 110 may also select multiple beneficiaries and an order in which they receive funds from the donated property that are conditional, based on one or more customized rules created by the Donor 110. For example, a Donor 110 could select their grandson's hockey registration fees as a first recipient and the American Lung Association's Anti-Smoking Campaign as a second recipient. In this example, the proceeds from the donated property would first cover the hockey registration fees and then any additional funds beyond this fee would be donated to the American Lung Association™, specifically, their Anti-Smoking Campaign as a tax deductible charitable contribution.

This optional feature is useful in cases where a specific individual beneficiary account may have a maximum value, such as registration for a particular event or activity. In cases where the donated property exceeds this maximum value from either a single Donor's 110 contribution or from multiple Donors' 110 contributions, the excess proceeds need to be distributed. It is envisioned that excess proceeds may also be transferred back to the Donors 110 themselves. This could be accomplished by a payment back to the Donor 110 or by the Donor 110 actually having their own unique Beneficiary ID and receiving the proceeds into their own recipient account.

In this way, it can be seen that the proceeds from the sale of donated property might result in a distribution of funds that has a portion that is charitable and tax deductible, as well as a portion that is not tax deductible. The specific distribution of funds to various accounts is tracked within the Transaction Database 270, and the Donation Management System 120 uses this data to provide detailed receipts to the Donor 110.

At Block 440, the Donor 110 decides whether they will be using a Selling Agent 130 or selling the donated property themselves. If the Donor 110 is using a Selling Agent 130, then the flow goes to Block 445 where the Donor 110 gives possession, but not title, of the property to the Selling Agent 130. The Donor 110 will also agree to costs and fees associated with using the selling agent's services and what will happen to the donated property if it does not sell in Marketplace 140. In the event that the donated property does not sell, the Donor 110 may in some instances receive the donated property back and in some instances have the Selling Agent 130 dispose of the unsold property on their behalf, such as donating the property outright to another charitable organization, which accepts donated property. If the Donor 110 is not using a Selling Agent 130, the donated property is listed in the Marketplace 140 at Block 450.

At Block 455, the property sells to a Buyer 160 and the flow moves to Block 460. If a Selling Agent 130 was used, the flow moves to Block 465 where payment from the Buyer 160 is sent to the Selling Agent 130. At Block 465, the Selling Agent 130 collects any additional fees associated with the sale of the donated property. Flow then moves to Block 470, or if no Selling Agent 130 was used, flow moves from Block 460 to Block 470. Money from the sale of donated property goes to Donation System Merchant Account 280 from the Buyer 160. At Block 470, any applicable fees are collected by the Donation Management System 120.

At Block 475, money is transferred from the Donation System Merchant Account 280 to the specific Beneficiary Merchant Account 380. These accounts can include checking accounts, PayPal™ accounts, or any other type of account. In some embodiments, there will be a specific account for each targeted Beneficiary Organization Member 358; in other embodiments, the Beneficiary Organization 150 may not have a specific account for each individual Beneficiary Organization Member 358. In the latter case, the Donation Management System 120 would transfer the money to the general Beneficiary Merchant Account 380 with the associated information detailing the specific Beneficiary Organization Member 358 who is the intended recipient of this donation (if appropriate). The Beneficiary Organization 150 would then handle the internal accounting and distribution of funds to Beneficiary Organization Members 358.

At Block 480, the Donor 110 is provided with receipts detailing the donation for tax and accounting purposes. In some embodiments, the Donor 110 may receive one or more receipts for donated property based on assessed fair market value at the time of donation, but prior to final sale and disposition of the property. After the sale of the property, the System 120 may generate a new receipt based on the actual final sale value of the donated property. In some embodiments, this new receipt is generated and provided to the Donor 110 only if the selling price of the donated property differs from the estimated fair market value by more than a selected threshold amount (e.g., 15%, 10%, 5%, zero, etc.). Receipts may be provided by a number of different methods including, but not limited to, email, online user accounts, paper reports and any other suitable communication method.

The process ends at Block 485, where the Transaction Database 270 is updated. The actual flow may be different from the flow presented in FIG. 4, with additional steps, steps happening in a different order or steps being executed concurrently. For example, the Transaction Database 270 may be updated in a number of places throughout the process.

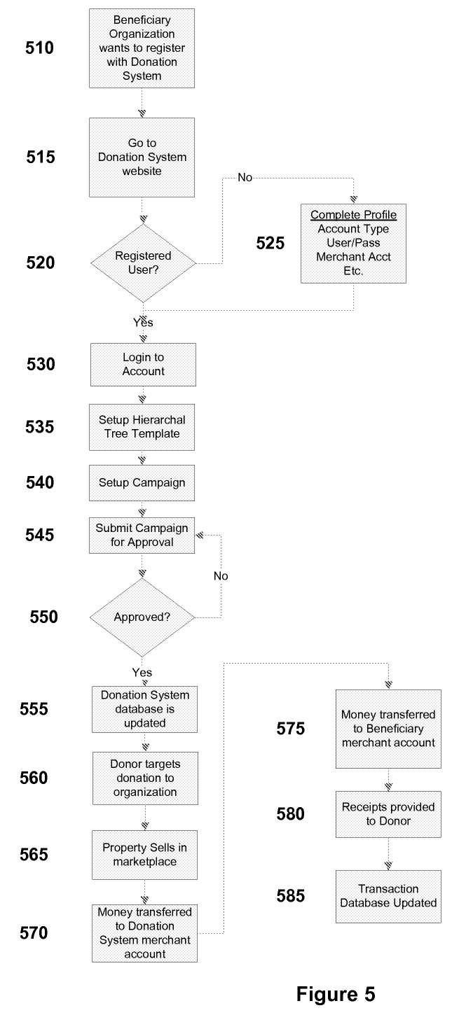

FIG. 5 is a simplified flow chart showing an exemplary use of the Donation System 120 from the perspective of a Beneficiary Organization 150. The flow chart begins at Block 510, where the Beneficiary Organization 150 wants to register with the Donation Management System 120 in order to receive funds from donated property.

At Block 515, the Beneficiary Organization 150 interacts with the Donation Management System 120 through the Beneficiary Interface 250. In this example, the interface 250 is a browser based interface that is connected to the Donation Management System 120 via the Internet. This connection to the Donation Management System 120 may happen directly or indirectly. The Beneficiary Organization 150 might, in some implementations, arrive at the Beneficiary Interface 250 through an agent, such as Selling Agent 130. This could be accomplished through an affiliated website and might be branded as the Selling Agent's 130 service.

At Block 520, the Beneficiary Organization 150 is queried about being a registered user of the Donation Management System 120. If they are not, they are presented with a new user account login at Block 525. Part of this login process involves determining the account type for the user. In this example, the account type is for a Beneficiary Organization 150. Other account types may include Donor/Seller, Beneficiary Member, Selling Agent/Power Seller, and Administrative account; other account types not listed could also be implemented.

At Block 530, the Beneficiary Organization 150 logs onto their account. The Beneficiary Organization 150 may update, edit or delete the information in their Beneficiary Organization account information contained in the Beneficiary Database 255.

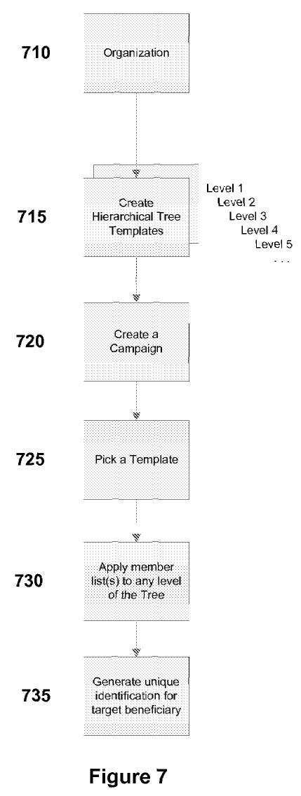

At Block 535, the Beneficiary Organization 150 either selects a pre-existing setup hierarchical tree template or creates a new tree template in order set up a specific campaign. These templates define a drill-down hierarchy, detailing the various levels at which donations may be targeted. Examples of templates will be discussed later in reference to FIGS. 7-9.

At Block 540, the Beneficiary Organization 150 populates the template with specific campaign attributes 356, program attributes 357, specific Beneficiary Member lists 358, associated Merchant Accounts 380 and any other relevant data. The campaigns entered may have any number of levels and associated Beneficiary Merchant Accounts 380. More detail about Beneficiary Organization levels will be discussed in reference to FIGS. 7-9.

The Beneficiary Organization 150 can add, modify and delete programs, campaigns, sub-campaigns and member accounts at any time. In some embodiments, the Beneficiary Organization 150 has the option to classify and tag a program, campaign, sub-campaign or target member account as private or public. If public, when the Donor 110 queries the database, the account search results are eligible for display to the Donor 110. If private, when the Donor 110 queries the database the target account may be filtered by the Beneficiary Organization 150 for display only to a subset of the public, or even outright blocking of display to the public, or to display only a subset of the information. For a member account, the member may have the ability to change account status to public or private, as well as deleting their account.

Block 545 is an optional block where the Donation Management System 120 or a third party can vet the proposed campaign before making it available for Donors 110 to access. This could be used to verify, for example, the tax exempt, non-profit status of Beneficiary Organization 150. Block 550 is an optional block related to Block 545. If the campaign is considered unacceptable for any reason, the Beneficiary Organization 150 may go back to Block 545 to make changes and resubmit the campaign for approval.

At Block 555, the Donation Management System Beneficiary Database 255 is updated with the new information and made available to Donors 110. At Block 560, a Donor 110 targets a donation of property to a Beneficiary Organization 150. In some cases, the Donor 110 can target the donation to specific Campaigns 356, Programs 357, and/or Members 358. A targeted Member 358 may be one of a plurality of recipient Members 358 for the proceeds from the sale of the property, and may also be a conditional recipient of the proceeds, as in the previously cited example involving a Donor's grandson and the American Lung Association™.

At Block 565, the property sells in the Marketplace 140. The property may have been sold directly by the Donor 110 or by a Selling Agent 130; in either case, the flow moves to Block 570 where the proceeds of the sale are transferred to the Donation Management System Merchant Account 280. In the case where the Donor 110 is the seller, the money may come directly from the Buyer 160 to the Donation Management System Merchant Account 280. In the case where there is a Selling Agent 130, the net proceeds, less the selling agent fees will be deposited into the Donation Management System Merchant Account 280. After collecting any costs/fees the money is transferred to the appropriate Beneficiary Merchant Account 380 at Block 575.

Although this example shows all funds going through the Donation Management System Merchant Account 280 before being transferred to the Beneficiary Organization Merchant Account 380, there are other possible configurations. For example, funds from either the Buyer 160 or the Selling Agent 130 may be deposited directly into Beneficiary Organization Merchant Accounts 380, with optional fees later remitted to the Donation Management System Merchant Account 280 by the Beneficiary Organization 150. It is understood that the Donation Management System 120 may apply different optional rates/fees for different types of donations. For example, the fee applied to cash donations may be different than those applied for donated non-cash property.

At Block 580, receipts are provided to the Donor 110 and to the Beneficiary Organization 150 giving the details of the transaction. The flow ends at Block 585, when the Transaction Database 270 is updated. The actual flow may be different from the flow presented here, with additional steps, steps happening in a different order or steps being executed concurrently. For example, the Transaction Database 270 may be updated in a number of places throughout the process.

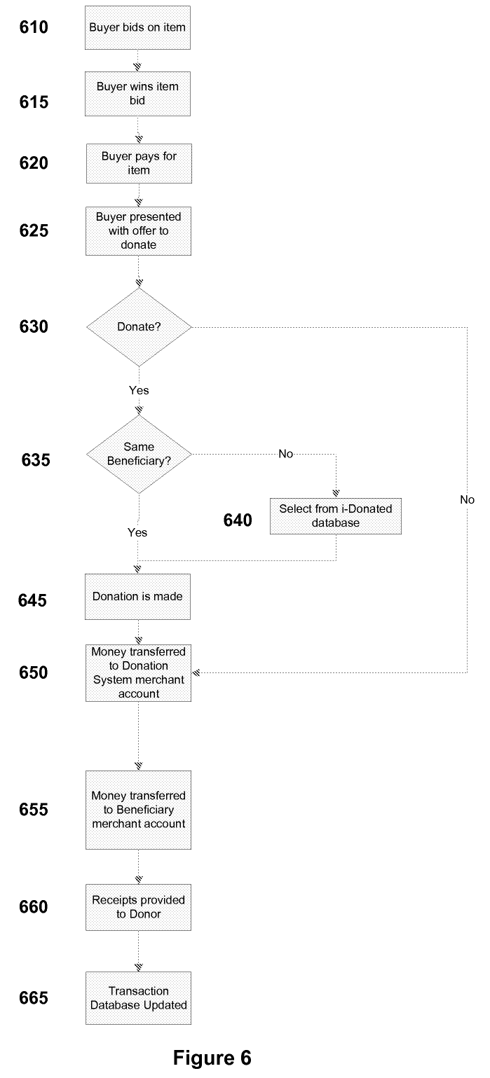

FIG. 6 is a simplified flow chart showing an exemplary use of the System 120 from the perspective of a Buyer 160. The flow chart begins at Block 610, where the Buyer 160 bids on donated property. At Block 615, the Buyer 160 wins the bid. In non-auction sales, the Buyer 160 simply buys the product in Marketplace 140 at a given price. At Block 620, the Buyer 160 pays for the item.

At Block 625, at the point where the Buyer 160 is in the checkout phase of the purchase, they are presented with an offer to donate. There are a number of ways to initiate this offer. In one embodiment, the Buyer 160 is, at the time of checkout, presented with a message stating that the proceeds from this auction are going to benefit a specific Beneficiary Organization 150 and presented with an offer to make a charitable contribution to that same Beneficiary Organization 150 or to a specific Beneficiary Organization Member 358. In cases where the donation is tax deductible, the Donor 110 would be notified of this and presented with information about receiving receipts for the donation.

If the Buyer 160 does not wish to support the Beneficiary Organization 150 that was already benefiting from the sale of the donated property just purchased by them, they could be presented with the entire Beneficiary Database 255 to select a different Beneficiary Organization 150 or specific Beneficiary Organization Member 358 to which to target a donation. It is also possible to present the option to donate to the specific Beneficiary Organization 150 benefiting from the sale or other Beneficiary Organizations 150 to all “potential purchasers” of the donated property. For example, in an auction context, potential purchasers could include any individuals who bid on the donated property, but did not win the bid. In other settings, potential purchasers could include any individuals who learn that the donated property is for sale, for example, by seeing the property displayed on a shelf at a physical store, by reviewing an advertisement about the property, etc. In this way, the potential donor pool is greatly increased for all Beneficiary Organizations 150 that are in the Beneficiary Database 255 in the Donation Management System 120.

At Block 630, the Buyer 160 decides whether or not they wish to make a donation to the specific Beneficiary Organization 150 or any other Beneficiary Organization 150. If the Buyer 160 does decide to make a donation, flow moves to Block 635. Also, in some implementations a Buyer 160, who did not make the winning bid may also decide to donate and would enter the flow at Block 630.

At Block 635, the Buyer 160 decides whether to donate to the same Beneficiary Organization 150 that is benefiting from the donated property sale. As discussed above, this beneficiary may be an organization 150, a specific Campaign/Sub-campaign 356/357 by that organization or even a specific Member 358 of a Beneficiary Organization 150. If the Buyer 160 decides to select a different recipient, the flow moves to Block 640 where the Buyer 160 is presented with other Beneficiary Organizations 150 in the Beneficiary Database 255 through Buyer Interface 260.

After selecting a Beneficiary Organization 150, either the original or a different beneficiary, the flow moves to Block 645 where the donation is made. This donation could be made in a number of ways, for example, by making a payment to the Donation Management System Merchant Account 280 targeted to the specific beneficiary. This payment might be a PayPal™ transaction. After the donation is made, flow continues to Block 650. If at Block 630, the Buyer 160 chooses not to make a donation, the flow moves directly from Block 630 to Block 650.

At Block 650, the money from the purchase of the donated property is transferred to the Donation Management System Merchant Account 280. As previously stated, the money may first go through a Selling Agent 130, who collects costs/fees associated with the sale of the donated property.

At Block 655, the net proceeds are transferred to the appropriate Beneficiary Merchant Account 380, after any optional costs/fees are collected by the Donation Management System 120. Although this example shows all funds going through the Donation Management System Merchant Account 280 before being transferred to the Beneficiary Organization Merchant Account 380, there are other possible configurations. For example, funds from either the Buyer 160 or the Selling Agent 130 may be deposited directly into Beneficiary Organization Merchant Accounts 380, with optional fees later remitted to the Donation Management System Merchant Account 280 by the Beneficiary Organization 150.

At Block 660, receipts are provided to the Donor 110 and to the Beneficiary Organization 150 giving the details of the transaction. The flow ends at Block 665 when the Transaction Database 270 is updated. The actual flow may be different from the flow presented here, with additional steps, steps happening in a different order or steps being executed concurrently. For example, the Transaction Database 270 may be updated in a number of places throughout the process.

FIGS. 7 through 9 will now be used to explain the hierarchies used by Beneficiary Organizations 150 for targeted donations. FIG. 7 shows a flow chart for setting up a specific campaign with targeted recipients. FIG. 7 expands on Blocks 535-555 in FIG. 5.

At Block 710, the Beneficiary Organization 150 has decided to use the Donation Management System 120 to accept proceeds from donated property. At Block 715, Beneficiary Organization 150 creates the hierarchical tree templates to be used for managing targeted donations. These templates may also be created by a Donation Management System 120 professional services arm or a third party such as Selling Agent 130.

At Block 720, a specific campaign is created which includes all attribute descriptions of the campaign. At Block 725, a tree template is selected which is then associated with the newly created campaign. At Block 730, individual member lists (containing multiple Members 358) can be applied to the template tree at any insertion point level. For example, a Beneficiary Organization 150 like Little League Baseball may have a campaign that uses a hierarchical tree template that has six drill-down sub-levels. (Little League: Region: State: Division: League: Team: Player). A list of Members 358 can be applied to one or more drill down levels, at any level of the hierarchical tree template. Furthermore, a list of Members 358 is not required to be applied to every level. Thus, a Donor 110 can give at any level of the tree hierarchy, even to specific individuals.

At Block 735, after any optional vetting and fine tuning of member lists at any level of the hierarchical tree, the Donation Management System 120 will generate a unique identifier for each level and each individual Member 358 associated at each level of the hierarchy. The Beneficiary Database 255 is then populated and activated and made available to Donors 110.

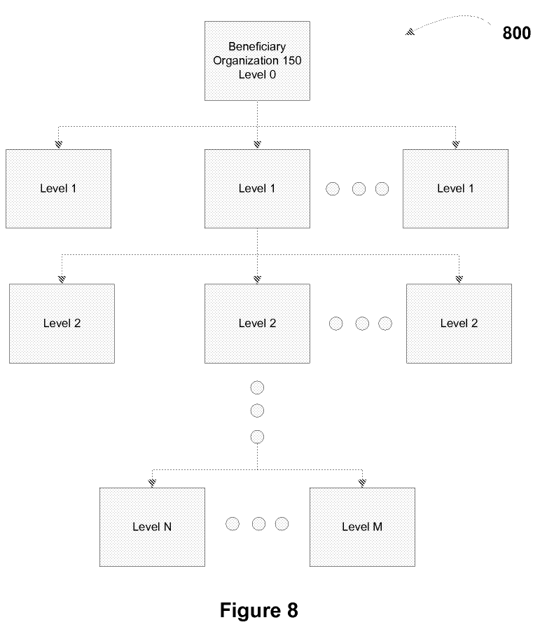

FIG. 8 shows a block diagram of a generic hierarchical tree template 800. The diagram illustrates that at each sublevel below the Beneficiary Organization 150 there may be one or more campaigns, with the ability to have one or more sub-campaigns levels for each of these subsequent levels.

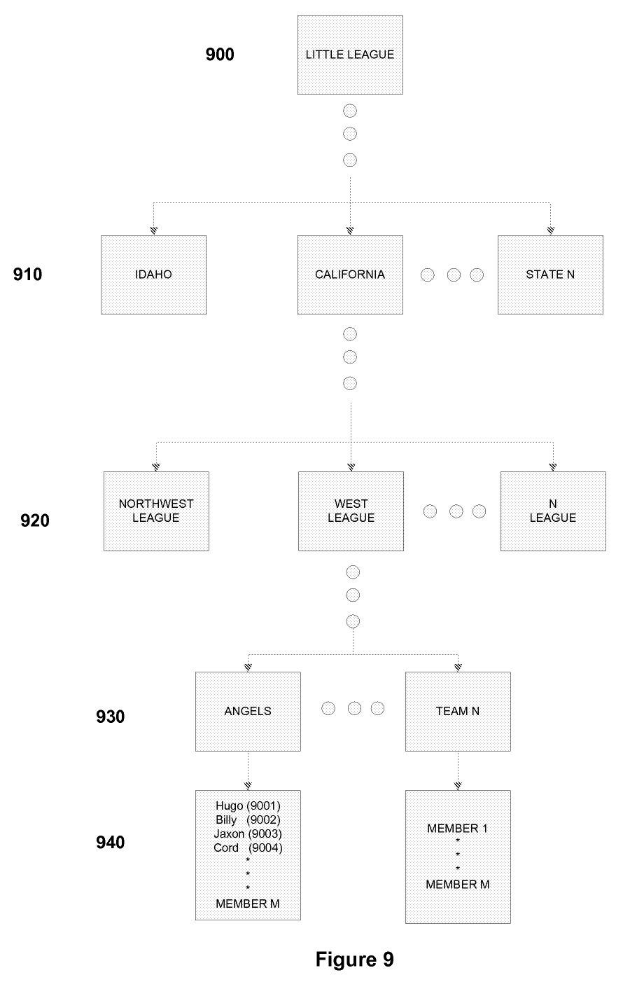

FIG. 9 provides an example of a Hierarchical Tree. It is a simplified version of the previous Little League example, showing four sublevels instead of six. In this case, the Beneficiary Organization 150 is Little League shown as 900 in FIG. 9. The first sub-level 910 shows participating states. A sub-level to the first sub-level 910 for California is made up of various leagues 920. A sub-level of the West League 920 comprises multiple teams 930. FIG. 9 is intended to show that there may be other levels between Little League 900 and States 910 and between States 910 and League 920, that is, Regions and Divisions respectively.

A sub-level of the Angels team 930 is a beneficiary member list 940. The beneficiary member list 940 is also represented in FIG. 3 as beneficiary member list 358. Beneficiary Organizations 150 may participate at any level. The Beneficiary Organization 150 is not required to register at the highest level. For example, referring to FIG. 9, the California Little League 910 could register with the Donation Management System 120 even if the national Little League 900 does not. Even a single Beneficiary Member 358 such as Billy (9002) from member list 940 in FIG. 9 could register to receive donations to pay for their participation fees in Little League.

Different portions of the same Beneficiary Organization 150 may register together or separately at the discretion of the Beneficiary Organization 150 itself. For example, the California Little League 910 and Idaho Little League 910 may register together or separately and manage their own member lists independently. They may also choose a different number of levels, to which Donors 110 may donate. For example, Idaho Little League 910 may choose to accept donations only at the Idaho state level 910, whereas the California Little League 910 may accept donations at the League Level 920, the Team level 930, and the individual player level 940.

A Donor 110 may choose to donate at any level provided by the Beneficiary Organization 150. For example, a Donor 110 may donate specifically to an individual player 940 such as Billy (9002), to a Team 930 (such as the Angels), to a League 920 (such as West League), to the State 910 (such as California), or to the general fund of the Beneficiary Organization 150 at level 900 of FIG. 9.

In some embodiments, the Donor 110 could donate at multiple levels or donate conditionally across one or more levels, and one or more Beneficiary Organizations 150. As an example of a conditional donation, a Donor 110 could donate property to cover the costs of Little League fees for their grandson Billy 940 (9002) of FIG. 9 with the condition that when Billy's fees are paid by the proceeds, any remaining funds can be applied to one or more Beneficiary Organizations 150 at any tree level, or the Donor 110 has the option to receive a cash credit. Furthermore, the Donor 110 may define a conditional program whereby target Beneficiary Members 358 are prioritized by the Donor 110 in advance, and allocations to multiple Beneficiary Accounts 380 are automatically applied in the prioritized order. For example, after Billy's Little League fees are paid in full, the Donor 110 has stipulated that the remaining amounts are split equally among Billy's teammates at level 940. If all teammates' fees are paid in full, then proceeds will be applied to the Angels 940 until an arbitrary limit is met, etc.

Although in a preferred embodiment, the System 120 is implemented in an online auction setting, any number of selling methods may be used with the System 120 including, but not limited to, consignment sales, live auctions, fixed priced auctions, silent auctions and traditional e-commerce storefronts. In addition, the System 120 may have different commission or payment models based on the type, condition and other product attributes as well as cash donations.

Hierarchical database schemas of organizations structure may vary from organization to organization. For example, some organizations may establish schemas to the sub-campaign level, while others may establish member accounts that are linked to a sub-campaign level, creating targeted accounts.

The System 120 presented may in some embodiments provide the ability for Donors 110 and for individual Beneficiary Members 358 to remain anonymous. In these cases the Beneficiary Database 255 and the Donor Database 215 would provide filtered data to the rest of Environment 100.

Although this invention has been described in terms of certain preferred embodiments, other embodiments that are apparent to those of ordinary skill in the art, including embodiments that do not provide all of the features and advantages set forth herein, are also included within the scope of this invention. Accordingly, the scope of the present invention is defined only by reference to the appended claims and equivalents thereof.

What is claimed is:

1. A method for managing donations comprising:
establishing a primary beneficiary account for each of a plurality of beneficiary organizations;
presenting the beneficiary organizations with an interface that enables the beneficiary organizations to create a plurality of beneficiary sub-accounts within their corresponding primary beneficiary account;
listing donated property as being for sale on behalf of a donor without accepting title to the donated property; and
depositing at least some of the proceeds from the sale of the donated property into one or more beneficiary sub-accounts designated by the donor.

2. The method of claim 1, wherein each of the plurality of beneficiary organizations is a non-profit organization.

3. The method of claim 1, wherein at least one beneficiary organization is a for-profit organization.

4. The method of claim 1, wherein at least some of the beneficiary sub-accounts comprise campaign sub-accounts, program sub-accounts, or member sub-accounts.

5. The method of claim 1, wherein enabling the beneficiary organizations to create a plurality of beneficiary sub-accounts comprises providing one or more generic hierarchical tree templates that can be used by the beneficiary organizations to simplify the process of account setup and management.

6. The method of claim 1, further comprising enabling one or more third parties to provide a value-added service to increase the value or salability of the donated property.

7. The method of claim 1, further comprising offering rewards to donors as an incentive to encourage donation activity.

8. A method for distributing the proceeds from the sale of donated property comprising:
establishing one or more beneficiary accounts for each of a plurality of beneficiaries, wherein at least one beneficiary account comprises a target amount;
receiving the proceeds from the sale of property sold by a donor; and
donating the proceeds from the sale of the property to a plurality of beneficiary accounts based on one or more customized rules created by the donor for distribution of the proceeds,
wherein at least one of the customized rules defines a sequence for distributing proceeds to the beneficiary accounts based on their associated target amounts.

9. The method of claim 8, wherein the property is sold in an online marketplace.

10. A method for reporting donation transactions, comprising:
receiving donated property from a donor;
providing a first receipt to the donor at the time the donated property is received, the first receipt indicating the estimated fair market value of the donated property;
selling the donated property in an online marketplace; and
determining whether the selling price of the donated property differs from the estimated fair market value by more than a selected threshold amount and, if so, providing the donor with a second receipt indicating the selling price of the donated property.

11. The method of claim 10, wherein the selected threshold amount is greater than zero.

12. A method for managing donations comprising:
receiving a cash donation from a donor, as well as donated property to be sold in an online marketplace;
transferring at least a portion of the cash donation to a designated beneficiary;
selling the donated property in the online marketplace; and
refunding to the donor at least a portion of the proceeds from the sale of the donated property.

13. The method of claim 12, wherein the online marketplace comprises an online auction marketplace.

14. A method for promoting donation activity comprising:
making donated property available for sale;
notifying potential purchasers of the donated property that the proceeds from the sale of the donated property will benefit one or more designated beneficiaries; and
enabling the potential purchasers to make a donation targeted to the one or more designated beneficiaries or to other beneficiaries.

15. The method of claim 14, wherein making the donated property available for sale comprises listing the property in an online marketplace.

16. The method of claim 14, wherein making the donated property available for sale comprises displaying the property in a physical store.

17. A method for targeting donations to specific beneficiaries, comprising:
establishing an account for one or more beneficiary organization members;
presenting a donor with an interface that enables the donor to target the proceeds from the sale of donated property to a selected account associated with a specific beneficiary organization member;
receiving the proceeds from the sale of the donated property sold in an online marketplace; and
depositing at least some of the proceeds from the sale of the donated property into the account selected by the donor.

18. The method of claim 17, wherein the online marketplace comprises an online auction marketplace.

19. The method of claim 17, wherein the donated property is sold by the donor in the online marketplace.

20. The method of claim 17, wherein the donated property is sold by a selling agent in the online marketplace.
